(19) United States
(12) Patent Application Publication
(10) Pub. No.: US 2023/0273321 A1
(43) Pub. Date: Aug. 31, 2023

(54) 3D Image Sensor Ranging System, and Ranging Method Using Same

(71) Applicant: Rayz Technologies Co. Ltd, Beijing (CN)

(72) Inventors: Ruxin Chen, Beijing (CN); Detao Du, Beijing (CN)

(21) Appl. No.: 18/304,845

(22) Filed: Apr. 21, 2023

Related U.S. Application Data
(63) Continuation of application No. PCT/CN2021/115878, filed on Sep. 1, 2021.

(30) Foreign Application Priority Data
Oct. 23, 2020 (CN) 202011149482.9

(51) Int. Cl. G01S 17/894; H04N 13/254; H04N 25/77; G01S 7/481; G01S 7/4865

(52) U.S. Cl. CPC G01S 17/894; G01S 7/4815; G01S 7/4816; G01S 7/4817; G01S 7/4865; H04N 13/254; H04N 25/77

(57) ABSTRACT

The present disclosure provides a 3D image sensor ranging system, a ranging method using the same, and an apparatus for optical ranging. The system comprises: at least one light-emitting unit array, each of the light-emitting unit array comprising at least one light-emitting unit, configured to emit light to a target scenario; at least one photosensitive unit array, each of the photosensitive unit array comprising at least one photosensitive unit, configured to receive at least a part of light emitted by the light-emitting unit and reflected by the target scenario, and generate a sensing tensor based on received light; and at least one computing component, configured to calculate at least one of a distance between the light-emitting unit and the target scenario or a light intensity of the reflected light of the emitted light, where the distance and the light intensity correspond to an angle of the emitted light, based on the sensing tensor generated by the at least one photosensitive unit.

### CROSS REFERENCE TO RELATED APPLICATIONS

This application is a continuation of International Application No. PCT/CN2021/115878, filed on Sep. 1, 2021, which claims priority to the Chinese patent application No. 202011149482.9 entitled “3D Image Sensor Ranging System and Ranging Method Using Same,” which was filed with the State Intellectual Property Office of China on Oct. 23, 2020. The entire disclosures of the aforementioned patent applications are hereby incorporated by reference into this application.

### TECHNICAL FIELD

Embodiments of the present disclosure relate to the field of Lidar ranging, in particular to a 3D image sensor ranging system and a ranging method using the system.

### BACKGROUND

Laser Lidar systems are becoming increasingly important in environmental identification. In particular, laser beams can be used to scan the surrounding environment and perform distance measurement on objects in the surrounding environment. A Lidar system typically includes at least one light source and one receiver, the light source is used to emit light towards the objects in the surrounding environment, and the receiver is used to receive light reflected by the objects. The Lidar system may determine a distance from an object to the Lidar system based on a time difference (i.e., time of flight of light) between the light source emitting light and the receiver receiving the light.

As the application of Lidar systems becomes more and more extensive, people are looking forward to having smaller-sized, longer-ranged and more efficient Lidar systems. However, in the process of integrating Lidar systems, how to improve efficiency, reduce size, and effectively avoid mutual interference between emitted light and reflected light is one of the urgent challenges to be solved.

### SUMMARY

In one aspect of the present disclosure, a 3D image sensor ranging system is disclosed. The system may include at least one light-emitting unit array, at least one photosensitive unit array and at least one computing component. Each of the light-emitting unit array may include at least one light-emitting unit configured to emit light to a target scenario. Each of the photosensitive unit array may include at least one photosensitive unit configured to receive at least a part of light emitted by the light-emitting unit array and reflected by the target scenario, and generate a sensing tensor based on the received light. The computing component is configured to calculate at least one of a distance between the light-emitting unit array and the target scenario or a light intensity of the reflected light based on the sensing tensor generated by the at least one photosensitive unit array.

In an embodiment, a divergence angle of the light emitted by the light-emitting unit fluctuates with time, where a maximum value of the divergence angle is greater than a first spatial resolution threshold. The first spatial resolution threshold may be greater than 2 times of a spatial resolution of the 3D image sensor ranging system.

The 3D image sensor ranging system according to an embodiment of the present disclosure may further include a scanning component, configured to control the light-emitting unit array to perform irradiation scanning in a spatial angle range corresponding to at least a part of the target scenario. As an option, at least a part of the light-emitting unit array includes a light-emitting scanning control component, configured to control the light-emitting unit array to perform irradiation scanning in the spatial angle range corresponding to at least a part of the target scenario.

In an example, within a first preset time range, a random error of an actual scanning spatial angle of the light emitted by the light-emitting unit array and a preset scanning spatial angle is greater than the first spatial resolution threshold, while an amount of the actual scanning spatial angle meets a first preset angle-ratio.

In an example, the sensing tensor may include at least one of: a distance between the light-emitting unit and the target scenario, a light intensity of the reflected light, a phase of the reflected light, or a spectrum of the reflected light. The computing component is configured to: obtain an emission time t0 of the light; obtain an arrival time t1 of a single photon or a single light pulse in the sensing tensor arriving at the photosensitive unit; determine the distance between the light-emitting unit and the target scenario based on the obtained t0 and t1; and determine the number of photosensitive electrons in the sensing tensor or a voltage reading of a collection capacitor in the photosensitive unit as the light intensity of the reflected light.

As an option, each of the photosensitive unit includes a first capacitor C1 and a second capacitor C2, and the computing component is configured to: obtain an emission time t0 of the light; obtain a voltage reading of the first capacitor C1 and a voltage reading of the second capacitor C2; determine an arrival time t1 of the light arriving at the photosensitive unit based on the voltage readings; calculate the distance between the light-emitting unit and the target scenario based on the obtained t0 and t1; and determine a sum of the voltage reading of the first capacitor C1 and the voltage reading of the second capacitor C2 as the light intensity of the emitted light.

As another option, the computing component is configured to: obtain an emission time t0 of the light, and a preset emitted light pulse width T0; obtain a time t_1 of the earliest electron group of 2 electrons arriving at a same photosensitive unit in the photosensitive unit array within a preset first time interval threshold T_1, where a time at which a second electron in the group arrives/appears at the same photosensitive unit is t_1+Δt₁, and at the same time, obtain the number n_1 of electron groups of 2 electrons arriving at the same photosensitive unit and satisfying the same interval condition, where Δt₁<T_1; then obtain a time t_m of the earliest electron group of m+1 electrons arriving at the same photosensitive unit within a preset m-th time interval threshold T_m in sequence, and at the same time obtain the number of electron groups n_m of m+1 electrons satisfying the same condition, where m is greater than or equal to 2; obtain an electron group arrival time t_max= {t_1, . . .,t_m} corresponding to a maximum electron group number n_max=max {n1, . . .,n_m} using corresponding electron group numbers n_1,...,n_m; determine the distance between the light-emitting unit and the target scenario based on a rule [distance= (t_max-t0) ×C/2 speed of light]; and determine the maximum electron group number n_max as the light intensity of the reflected light.

In another embodiment, according to a predetermined pattern, the system calculates the maximum electron group number n_best and the corresponding electron group arrival time t_best corresponding to the emitted light pulse according to the above { n1,. . .,n_m} and {T_1, . . .,T_m}, and then determines the distance between the light-emitting unit array and the target scenario based on a rule [distance= (t_best-t0) ×C/2 speed of light]; and determines the maximum electron group number n_best as the light intensity of the reflected light.

As a further exemplary option, the computing component may be further configured to: obtain an emission time t0 of the light; obtain a time t_1 of the earliest 2 electron groups simultaneously arriving at different but adjacent photosensitive units in the photosensitive unit array within a preset first time interval threshold, and at the same time obtain the number n_1 of electron groups of 2 electrons arriving at the adjacent photosensitive units and satisfying the same interval condition; then obtain a time t_m of the earliest m+1 electron groups arriving within a preset m-th time interval threshold in sequence, and at the same time obtain the number n_m of electron groups of m+1 electrons arriving at the adjacent photosensitive units and satisfying the same interval condition, where m≥2, and a corresponding electron group number n_m, and obtain an electron group arrival time t_max corresponding to a maximum electron group number n_max; determine the distance between the light-emitting unit array and the target scenario based on a rule [distance= (t_max-t0) ×C/2 speed of light/2]; and determine the maximum electron group number n_max as the light intensity of the reflected light.

In an exemplary implementation, the computing component is configured to: determine whether to emit detection light at a current scanning point based on a previous sensing tensor before a current scanning point in a process of performing scanning according to a predetermined pattern, where there is at least the number of times no detection light is emitted within a second preset time range, the number of times satisfying a second preset non-emission ratio. For example, when the computing component determines that at least two light-emitting units scan the target scenario successively with strong light and weak light, respectively, and if the distance between the light-emitting unit array and the target scenario has been obtained by measuring during the scan with the weak light, it is determined that detection light is not emitted at the current scanning point; or, when the computing component determines that the distance detected at a current light intensity is less than a predetermined value or greater than the predetermined value, it is determined that detection light is not emitted at the current scanning point; or, when the computing component determines that a currently scanned target area is an unimportant and unattended area, it is determined that a current light emission should be skipped according to the second preset non-emission ratio; or, when the computing component determines that the divergence angle of a scan within the second preset time range has detected most of current pixels, it is determined that detection light is not emitted at the current scanning point. In the present disclosure, the second preset non-emission ratio may be 1%, 5%, 20%, 30%, or 80%. In addition, the computing component is configured to determine before each scan whether to emit detection light at the current scanning point.

In an embodiment, the computing component is configured to: determine, for the current scanning point, at least one sensing tensor obtained through a previous measurement that is closest in terms of time; determine at least another previous measurement that is closest in terms of spatial angle; and determine, based on the determined sensing tensor and the determined measurement, whether to emit the detection light at the current scanning point. The computing component is configured to perform following steps to obtain the sensing tensor: 1) acquire a first sensing tensor in a previous period temporally closest to the current scanning point; 2) acquire a second sensing tensor in a current period spatially closest to the current scanning point; 3) predict, based on the first sensing tensor and the second sensing tensor, a scanning characteristic of the current scanning point, where the scanning characteristic may include at least one of an emission intensity, an emission frequency, an emission area, a pulse distinguishable characteristic, an attention, or a scanning area of the current scanning point; and 4) determine, based on the determined scanning characteristic, whether the light-emitting unit is currently allowed to perform an operation of emitting the detection light; and if yes, obtain a sensing tensor of a largest possibly covered photosensitive unit corresponding to a current scanning angle and a current divergence angle; or if not, return to step 1) and re-perform step 1) to step 4).

In an embodiment, each photosensitive unit is configured to: determine whether the number or an amplitude of photosensitive electrons in received light pulses is less than a predetermined electron number threshold or a signal amplitude threshold; and if yes, discard information included in the light, where the electron number threshold and the signal amplitude threshold gradually decrease from a preset threshold with time at beginning of emission according to a preset pattern. Beams emitted simultaneously by at least two light-emitting units in the light-emitting unit array at least partially overlap in a spatial angle, and a wavelength range included in each of the beams is at least partially different. The light emitted by the light-emitting unit may include scanning beams of at least two different divergence angles.

In an embodiment of the present disclosure, the computing component is further configured to obtain at least one subregion of interest in the target scenario using the sensing tensor measured in the previous second preset time range; and send an instruction such that: in a third preset time range, compared to other regions, a scanning density of the subregion of interest is greater than a first multiple threshold, and/or a scanning frequency of the subregion of interest is greater or less than a second multiple threshold, and/or an average light energy of the subregion of interest per unit time is greater or less than a third multiple threshold. As an example, the at least one subregion of interest may be determined by an embedded calculation and/or preset pattern in the light-emitting unit, where the light-emitting unit outputs a sensing tensor with the number of subpixels of an image sensor less than the second preset ratio.

In another aspect of the present disclosure, a ranging method using the 3D image sensor ranging system is further provided, including: emitting light to at least one target scenario through a light-emitting unit included in at least one light-emitting unit array; receiving at least a part of light emitted by the light-emitting unit and reflected by the target scenario through a photosensitive unit, and generating a sensing tensor based on the received light; and calculating at least one of a distance between the light-emitting unit array and the target scenario or a light intensity of the reflected light, based on the generated sensing tensor.

In another aspect of the present disclosure, an apparatus is further provided, including: at least one 3D image sensor ranging system as described in any one of the above embodiments; and a semiconductor chip for integrating the at least one 3D image sensor ranging system therein.

In another aspect of the present disclosure, a method for forming an apparatus for optical ranging is further provided, including: forming at least one 3D image sensor ranging system as described in any one of the above embodiments, and integrating the at least one 3D image sensor ranging system in a same semiconductor chip.

### BRIEF DESCRIPTION OF THE DRAWINGS

Other features, objectives and advantages of the present disclosure will become more apparent by reading detailed descriptions of non-limiting embodiments made with reference to the following accompanying drawings:

FIG. 1 is an exemplary system architecture diagram of a 3D image sensor ranging system according to an embodiment of the present disclosure;

FIG. 2 is an exemplary system architecture diagram of the 3D image sensor ranging system according to another embodiment of the present disclosure;

FIG. 3 is a schematic diagram of overlapping beams emitted by a light-emitting unit according to another embodiment of the present disclosure;

FIG. 4 is a flowchart for obtaining a sensing tensor according to another embodiment of the present disclosure;

FIG. 5 is a schematic diagram of a circuit structure of a photosensitive unit according to another embodiment of the present disclosure;

FIG. 6 is a method flowchart for ranging using a 3D image sensor ranging system according to another embodiment of the present disclosure; and

FIG. 7 is a schematic structural diagram of a computer system of an electronic device suitable for implementing a 3D imaging method of an embodiment of the present disclosure.

### DETAILED DESCRIPTION OF EMBODIMENTS

For a better understanding of the present disclosure, various aspects of the present disclosure will be described in more detail with reference to the accompanying drawings. It should be understood that these detailed descriptions are merely illustrative of exemplary embodiments of the present disclosure and are not intended to limit the scope of the present disclosure in any way. Throughout the specification, the same reference numerals refer to the same elements. The expression “and/or” includes any and all combinations of one or more of the associated listed items. It may be understood that the embodiments described herein are only used to explain the relevant disclosure, but not to limit the disclosure. In addition, it should be noted that, for ease of description, only the parts related to the relevant disclosure are shown in the accompanying drawings.

Features described in the present disclosure may be implemented in different forms and should not be construed as being limited to examples described in the present disclosure. More precisely, the examples described in the present disclosure are provided only to illustrate some of the many possible ways of implementing methods, apparatuses and/or systems described in the present disclosure, which will become apparent upon understanding the disclosure of the present disclosure.

The use of the word “may” in relation to an example or embodiment (e.g., with respect to what an example or embodiment may include or achieve) means that there is at least one example or embodiment that includes or achieves such a feature, but the full range of examples or embodiments is not limited thereto.

It should be noted that, in the specification, the expressions such as “first,” and “second” are only used to distinguish one feature from another, rather than represent any limitations to the features.

In the accompanying drawings, the thicknesses, sizes and shapes of the components are slightly exaggerated for the convenience of explanation. Specifically, shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Throughout the specification, when, for example, an element is described as being “on”, “connected to”, or “coupled to” another element, the element may be directly “on”, directly “connected to”, or directly “coupled to” the other element, or there may be one or more other elements between the element and the other element. Conversely, when an element is described as being “directly on”, “directly connected to”, or “directly coupled to” another element, there may be no other element between the element and the other element.

For ease of description, spatially relative terms such as “above”, “higher”, “below” and “lower” may be used in the present disclosure to describe the relationship between one element and another element as shown in the accompanying drawings. These spatially relative terms are intended to include different orientations of a device in use or operation, in addition to the orientations depicted in the accompanying drawings. For example, if a device in the accompanying drawings is turned over, an element described as being “above” or “higher” relative to another element will be “below” or “lower” relative to that other element. Thus, depending on the spatial orientation of the device, the term “above” includes “above” and “below”. The device may also be oriented in other ways (e.g., rotated by 90 degrees or in other orientations) and the spatially relative terms used herein should be interpreted accordingly.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list.

As used herein, the words “approximately,” “about,” and similar words are used as words of approximation, not as words of degree, and are intended to describe the inherent bias in measured or calculated values that those of ordinary skill in the art would recognize.

Unless otherwise defined, all terms (including technical terms and scientific terms) used herein have the same meaning as commonly understood by those of ordinary skill in the art to which the present disclosure belongs. It should be further understood that terms (i.e., those defined in commonly used dictionaries) should be interpreted as having meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. Further, unless expressly limited or contradicted by the context, the specific steps contained in the methods described in the present disclosure are not limited to the sequence described, but may be performed in any order or in parallel.

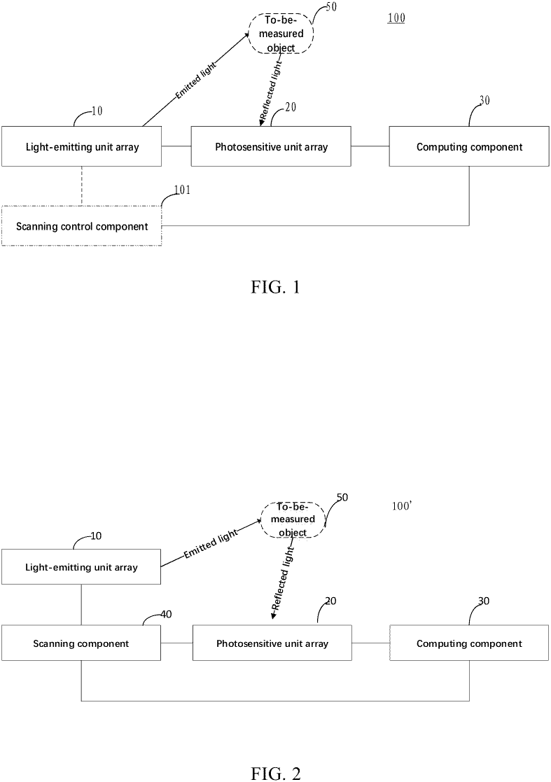

FIG. 1 shows a 3D image sensor ranging system 100 according to an embodiment of the present disclosure. As shown, the 3D image sensor ranging system 100 may include at least one light-emitting unit array 10, at least one photosensitive unit array 20 and at least one computing component 30. The at least one light-emitting unit array 10 may include at least one light-emitting unit configured to emit light to at least one target scenario. Each of the photosensitive unit array 20 includes at least one photosensitive unit configured to receive at least a part of light emitted by the light-emitting unit array and reflected by the target scenario, and generate a sensing tensor based on the received light. Each computing component 30 is configured to, based on the sensing tensor generated by the at least one photosensitive unit array 20, calculate at least one of: 1) a distance between the light-emitting unit and the target scenario; or 2) a light intensity of the reflected light.

### Light-Emitting Unit Array 10

The light-emitting unit array 10 includes at least one light-emitting unit. The light-emitting unit is configured to emit light pulses to the target scenario according to a predetermined pattern to illuminate the target scenario. For example, the light pulses may be emitted to the target scenario according to a preset pattern. The light-emitting unit array 10 may emit light pulses having a wavelength within a range of, for example, 300 nm-750 nm, 700 nm-1000 nm, 900 nm-1600 nm, 1 um-5 um, or 3 um-15 um. A pulse width may be, for example, 0.1 ps-5 ns, 1 ns-100 ns, 100 ns-10 us, or 10 us-10 ms. Parameters of the wavelength and the pulse width of the light pulses emitted by the light-emitting unit array 10 are exemplified here by way of example only, however, the present disclosure is not limited therein, other parameters of the wavelength and the pulse width that do not deviate from the teachings of the present disclosure are also allowed.

In some embodiments, each light-emitting unit may be a semiconductor laser, a fiber laser, a solid-state laser. In some embodiments, the light pulses emitted by each light-emitting unit may be modulated linear polarized light, circular polarized light, elliptical polarized light, or unpolarized light. A pulse re-frequency of the light pulses may be selected from a range of 1 Hz-100 Hz, 100 Hz-10 kHz, 10 kHz-1 MHz, or 1 MHz-100 MHz. A coherence length of the light pulses may be less than 100 m, 10 m, 1 m, or 1 mm. The light pulses emitted by each light-emitting unit are toward the target scenario. The target scenario may include, for example, a to-be-measured object 50.

A maximum value of a divergence angle of the light-emitting unit, which fluctuates with time, is greater than a first spatial resolution threshold. The divergence angle of the light emitted by each light-emitting unit toward the target scenario 50 is greater than the first spatial resolution threshold, where the first spatial resolution threshold includes a horizontal first spatial resolution threshold and a vertical first spatial resolution threshold. The horizontal first spatial resolution threshold may be 0.1°, 1°, 2°, 5°, 10°, or 0.01*system horizontal field-of-view (FOV), or 0.02*system horizontal FOV, or 0.1*system horizontal FOV. The vertical first spatial resolution threshold may be 0.1°, 1°, 2°, 5°, 10°, or 0.01*system vertical FOV, or 0.02*system vertical FOV, or 0.1*system vertical FOV.

The 3D image sensor ranging system 100 may further include a light-emitting scanning control component 101 that may be integrated with at least a part of the light-emitting units of the light-emitting unit array 10. In FIG. 1, the light-emitting scanning control component 101 is shown with dashed lines indicating that the component 101 may be integrated into the light-emitting unit array 10. The scanning control component 101 is capable of controlling scanning toward a spatial angle range corresponding to at least a part of the target scenario, i.e., for controlling all emitted light of the light-emitting unit array 10. For example, if the target scenario is described by horizontal angle x (such as taking a range: 1-1000), and vertical angle y (such as taking a range: 1-200), general scanning of a single beam is to let light spots illuminate a center of all two hundred grids of (1-1000) × (1-200) according to a simple pattern. This simple scanning pattern is for example: 1) when vertical=1, the horizontal scan is performed from 1 to 1000 with a step of; then 2) when vertical=2, the horizontal scan is performed again from 1 to 1000 with a step of 1. The divergence angle of the emission line of a typical LiDAR is optimized to keep the size smaller than, for example, 200 × 1000 grids. However, when the divergence angle is large, the light spots of one beam may illuminate several grids at the same time. With the existing Lidar, scanning is designed in such a way that a path of the scanning is fixed, and it does not consider whether divergent light spots cover several girds. However, when n × m grids covered by light spot (such as 3 × 3 grids covered by light spots) may be effectively detected at the same time, a scan does not need to move horizontally by 1 for the next horizontal scan, or move vertically by 1 each time. When an angular trajectory of single-beam scanning is controlled to move randomly/fuzzy in a certain range, it is necessary that the divergence angle of the beam also varies randomly/fuzzy in a certain range, which ensures that the light spots can completely cover all the grids defined by a spatial angular resolution defined by the target scenario in a certain time.

Simply put, the larger the divergence angle of the emitted light, the less optical scanning is performed on the target scenario using that light. However, the larger the divergence angle, the smaller a maximum distance that a detector (i.e., the photosensitive unit array 20) can detect. One of the objectives of the present disclosure is to use a possibly low-quality, low-cost light emission and scanning system while achieving a configurable optimal system resolution, distance range, and output point cloud number rate.

In an embodiment, the light-emitting scanning control component 101 is configured to cause the light emitted by the light-emitting unit to satisfy: within a first preset time range, at least a random error of an actual scanning spatial angle of a first preset angle-ratio and a preset scanning spatial angle is greater than the first spatial resolution threshold, where the first spatial resolution threshold is greater than 2 times of a spatial resolution of the present system. It should be understood that an ordinary Lidar, in general, has a system designed spatial resolution, such as a horizontal resolution of 0.1 degrees. Then, when an ordinary mechanical scanning Lidar scans horizontally, the system emits a laser every 0.1 degrees in order to obtain a spatial resolution of 0.1 degrees in the horizontal direction. Similarly, vertical scanning may be performed to obtain a desired vertical scan. The prior scanning Lidars generally operate according to such principle. The use of a corresponding Flash Lidar is similar to that of ordinary cameras, except that it emits a laser flash that illuminates the whole scenario. Similar to ordinary cameras, it has a special image sensor of m × n pixels, such as a traditional camera having 1024 × 768 pixels, then, when an angle-of-view of the camera (determined by an optical lens assembly of the camera) is 100 degrees horizontally and 76 degrees vertically, the horizontal resolution of the camera or the Flash Lidar is 100/1204≈0.1 degrees, and the vertical resolution is 76/768≈0.1 degrees. In the present disclosure, by intentionally designing a large scanning error, the purpose of reducing system costs may be achieved, and the random error is beneficial to ensure full coverage of the scenario by the emitted light, at the same time greatly reduce the system costs.

In addition, in a conventional scanning Lidar system, the system intends to emit a laser that is as fine as possible in perpetually parallel so that the system obtains the best angular resolution and signal-to-noise ratio, but this is difficult to achieve precise control, especially when a semiconductor (or no mechanical scanning device) controls the emission. In ordinary ranging schemes, a smaller divergence angle is preferred, and the divergence angle is fixed/constant. In this embodiment of the present disclosure, the control of the fixed divergence angle is loosened, so that the divergence angle of the emitted light fluctuates within a range beneficial to a manufacturing cost. For the fluctuation of the divergence angle, in a 0.1 degree resolution system, the divergence angle may be 1 degree, 2 degrees, or 3 degrees. Optimization of system setup is to balance a power of the emitted light, the maximum measured distance, a photoelectric efficiency of a detection sensor, and the manufacturing cost.

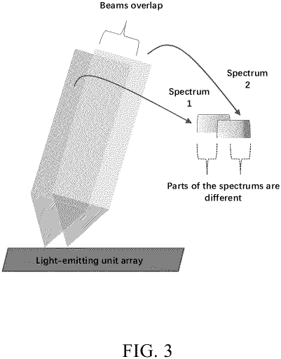

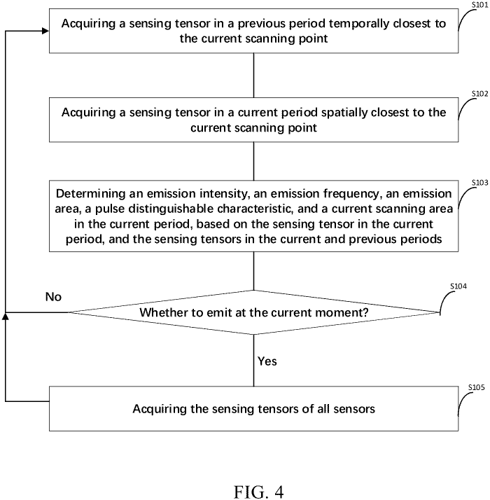

In addition, beams emitted simultaneously by at least two light-emitting units in the light-emitting unit array 10 at least partially overlap in a spatial angle, and a wavelength range included in each of the beams is at least partially different. The light emitted by the light-emitting unit 10 may include scanning beams of at least two different divergence angles, as shown in FIG. 3. In addition, through the above configuration, a laser beam having a larger cross-section may be emitted, so that the divergence angle is small, the ranging is farther, at the same time, corresponding objects with closer pixel pitch may be detected, so that a subspace resolution is better.

### Photosensitive Unit Array 20

The photosensitive unit array 20 includes at least one photosensitive unit. The photosensitive unit array is configured to receive at least a part of light reflected by the target scenario, and provide at least a portion of the sensing tensor included in information of the reflected light to the computing component 30, where each sensing tensor may include at least one of: a distance between the light-emitting unit and the target object, a light intensity of the emitted light, a phase of the emitted light, or a spectrum of the emitted light.

In an example, the photosensitive unit may include a photoelectric sensor and an optical filter (not shown). The photoelectric sensor generates photosensitive electrons in response to receiving the reflected light through a photoelectric effect. The corresponding light intensity may be obtained by calculating the number of photosensitive electrons, and the corresponding distance between the light-emitting unit and the target scenario may be determined by calculating a time interval of generation time of the photosensitive electrons and the emitted light multiplied by the speed of light. The optical filter may be set in front of the photoelectric sensor to obtain the light intensity of a specific band, so as to obtain the spectrum of the specific band by modulating and demodulating light of the specific band. A phase of the light modulated at a low frequency may be obtained by modulating and demodulating an electrical signal of the same frequency. In addition, the phase of the beam itself may also be obtained through the generation time and space of the photosensitive electrons.

For example, in an embodiment, at least one photosensitive unit (herein also referred to as “pixel”) collects electrons associated with the photosensitive electrons during exposure using at least 2 capacitors, and calculates the sensing tensor of the corresponding pixel using measurements of the at least 2 capacitors at the end of exposure. A photoelectric converter in the photosensitive unit may convert an optical signal into an electrical signal. In this way, by processing the electrical signal, image information of points in the target scenario may be restored.

In particular, during the exposure, the light emitted by the light-emitting unit is reflected by various points in the target scenario, and the obtained reflected light may enter the photoelectric converter. The photoelectric converter converts the optical signal into the corresponding electrical signal by photoelectric conversion of the light reflected by the target scenario during the exposure. Here, a signal value of the electrical signal may be represented, for example, by the number of photosensitive electrons (i.e., the number of charges) obtained after photoelectric conversion of the optical signal. For a determined photoelectric converter, a functional relationship between the optical signal before the photoelectric conversion and the electrical signal after the photoelectric conversion is known. Therefore, by detecting the signal value of the electrical signal, the sensing tensor of each pixel corresponding to the target scenario may be calculated, and then the image information of the points in the target scenario may be restored. In the embodiment, the sensing tensor of each pixel may be, for example, a set of data including information such as the distance, light intensity, phase, and spectrum of the pixel.

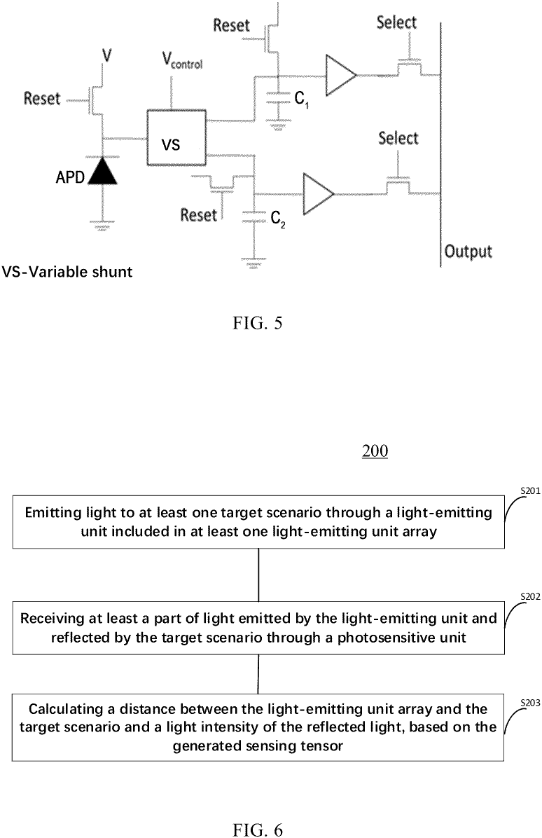

As described above, the signal value of the electrical signal obtained after photoelectric conversion may be represented by the number of charges obtained by photoelectric conversion. In an embodiment, in each photosensitive unit in the photosensitive unit array, at least 2 capacitors are used to collect the photosensitive electrons during the exposure (i.e., the charges obtained after photoelectric conversion), where the at least 2 capacitors have different charge-discharge characteristics. FIG. 5 exemplarily illustrates a schematic diagram of a circuit structure of a photosensitive unit according to an embodiment of the present disclosure. As shown in FIG. 5, the photosensitive unit may include two capacitors C1 and C2, a variable shunt, and an avalanche diode APD (or a single-photon avalanche diode (SPAD), a photodiode PD). When an optical signal incident at a moment t1 is converted into an electrical signal in a photosensitive interval, under the control of a time-variable shunt, a part q1 of the photosensitive electrons is delivered to the capacitor C1, and the other a part q2 of the photosensitive electrons is delivered to the capacitor C2, where q1+q2 is the total number of electrons generated at the moment t1. When an optical signal incident at another moment t2 is converted into an electrical signal in the photosensitive interval, under the control of the variable shunt, a part q1′ of the photosensitive electrons is delivered to the capacitor C1, and the other a part q2′ of the photosensitive electrons is delivered to the capacitor C2, where q1′+q2′ is the total number of electrons generated at the moment t2. Because a shunt ratio of the shunt varies over time, q1/q2 and q1′/q2′ are also different, and this ratio value corresponds to a definite time. The use of common electrical devices in FIG. 5 represents a schematic diagram of components used in a specific embodiment, the components are conventional components having their own properties and functions, so the components are not described individually, but for clarity, in FIG. 5, symbols such as reset, gate control select, control input Vcontrol of the variable shunt, and output are kept as reference numerals.

At the end of exposure, the measurements of the above 2 capacitors C1 and C2 (i.e., the charges collected by the capacitors) are amplified, read, and used to calculate the sensing tensor (e.g., distance, light intensity, phase, and spectrum, etc.) of the corresponding pixel. The specific processing of obtaining the distance and the light intensity with reference to the measurements of the capacitors C1 and C2 will be further described below with reference to the computing component 30, as for obtaining the phase and the spectrum, etc. based on the measurements of the capacitors C1 and C2, it may be implemented using the existing technology.

In addition, in the present disclosure, the time for each emission of light by the light-emitting unit array 20 is referred to as exposure time, and a photoelectric sensing unit in the photosensitive unit receives at least a part of the light reflected by the target scenario and converts it into photosensitive electronic information. When the number of electrons or a signal amplitude in the photosensitive electronic information is less than a preset threshold in the photosensitive unit, no subsequent processing is performed on the photosensitive electronic information this time, and an electron number threshold and a signal amplitude threshold gradually decrease from the preset threshold with time at beginning of emission according to a preset pattern. Specifically, each photosensitive unit in the photosensitive unit array 20 may be further configured to: determine whether the number or an amplitude of photosensitive electrons in received light pulses is less than a predetermined electron number threshold or a signal amplitude threshold, and if yes, discard information included in the light pulses, where the electron number threshold and the signal amplitude threshold gradually decrease from a preset threshold with time at beginning of emission according to a preset pattern. The reason why the electron number threshold and the signal amplitude threshold are limited to decrease with time is that: the later the signal arrives the weaker the intensity, while the earlier the signal arrives, the stronger a stray light signal, and by the gradually decreasing threshold, it can improve an anti-interference energy of the system, avoid unnecessary detection time, and make better preparation for long-distance weak signals.

The photosensitive unit includes at least one of APD, photodiode (PD) or single photon avalanche diode (SPAD) (SiPM on silicon base or synthetic materials generated from group 3-5 elements such as InGaAs).

### Computing Component 30

The computing component 30 calculates the distance between the target scenario corresponding to each photosensitive unit (photosensitive pixel) and the light-emitting unit and a relative light intensity of the reflected light based on the above sensing tensor measured by the photosensitive unit array 20.

In an example, the sensing tensor may include at least one of: a distance between the emitted light and the target scenario, the light intensity of the reflected light, a phase of the reflected light, or a spectrum of the reflected light.

In an embodiment, a method for the computing component 30 to calculate the corresponding distance of the target scenario and the light intensity of the reflected light may include: 1) obtaining an emission time t0 of the light; 2) obtaining a time t1 of a single photon or a single light pulse (multiphoton) in the sensing tensor; 3) distance= (t1-t0) ×C speed of light/2; and 4) obtaining the number of photosensitive electrons in the sensing tensor or a voltage reading of a collection capacitor and determining as the light intensity.

In another embodiment, at least one photosensitive unit/pixel in the photosensitive unit array 20 collects electrons associated with the photosensitive electrons during exposure using at least 2 capacitors, and calculates the sensing tensor of the corresponding pixel using measurements of the at least 2 capacitors at the end of exposure. Accordingly, a method for the computing component 30 to calculate the corresponding distance of the target scenario and the light intensity of the reflected light may include: 1) obtaining an emission time t0 of the light; 2) obtaining a reading of the capacitor C1 and a reading of the capacitor C2; 3) determining an arrival time t1 of the light arriving at the photosensitive unit based on the voltage readings; 4) calculating the distance between the emitted light and the target scenario 50 through a formula, i.e., distance= (t1-t0) ×C speed of light/2; and 5) then calculating the light intensity of the emitted light=value of C1+value of C2.

In another embodiment, a method for the computing component 30 to calculate the corresponding distance of the target scenario and the light intensity of the reflected light may include:
obtaining an emission time t0 of the light, and a preset emitted light pulse width T0;
obtaining a time t_1 of the earliest electron group of 2 electrons arriving at a same photosensitive unit in the photosensitive unit array within a preset first time interval threshold T_1, where a time at which a second electron in the group arrives/appears at the same photosensitive unit is t_1+Δt₁, and at the same time obtaining the number n_1 of electron groups of 2 electrons arriving at the same photosensitive unit and satisfying the same interval condition, where Δt₁<T_1;
then obtaining a time t_m of the earliest electron group of m+1 electrons arriving at the same photosensitive unit within a preset m-th time interval threshold T_m in sequence, and at the same time obtaining the number n_m of electron groups of m+1 electrons satisfying the same condition, where m is greater than or equal to 2;
obtaining an electron group arrival time t_max={t_1, ...,t_m} corresponding to a maximum electron group number n_max=max{n1, ...,n_m} using corresponding electron group numbers n_1,...,n_m;
determining the distance between the light-emitting unit array and the target scenario based on a rule [distance= (t_max-t0) ×C/2 speed of light]; and
determining the maximum electron group number n_max as the light intensity.

In another embodiment, a method for the computing component 30 to calculate the corresponding distance of the target scenario and the light intensity of the reflected light may include:
obtaining an emission time t0 of the light;
obtaining a time t_1 of the earliest 2 electron groups simultaneously arriving at different but adjacent photosensitive units in the photosensitive unit array within a preset first time interval threshold, and at the same time obtaining the number n_1 of electron groups of 2 electrons arriving at the adjacent photosensitive units and satisfying the same interval condition;
then obtaining a time t_m of the earliest m+1 electron groups arriving within a preset m-th time interval threshold in sequence, and at the same time obtaining the number n_m of electron groups of m+1 electrons arriving at the adjacent photosensitive units and satisfying the same interval condition, where m≥2, and a corresponding electron group number n_m, and obtaining an electron group arrival time t_max corresponding to a maximum electron group number n_max;
determining the distance between the light-emitting unit array and the target scenario based on a rule [distance= (t_max-t0) ×C/2 speed of light/2] ; and
determining the maximum electron group number n_max as the light intensity of the reflected light.

The computing component 30 is further configured to: determine whether to emit detection light at a current scanning point based on a previous sensing tensor in a process of scanning the emitted light according to a predetermined pattern, and send a corresponding execution instruction to the scanning control component 101 (to control whether to emit a beam for scanning at the target object based on quality), where there is at least the number of times no detection light is emitted within a second preset time range, the number of times satisfying a second preset non-emission ratio. For example, the second preset non-emission ratio may be 1%, 5%, 20%, 30%, or 80%. As an example, when the computing component 30 determines that at least two light-emitting units scan the target scenario successively with strong light and weak light, respectively, and if the distance has been obtained by measuring during the scan with the weak light, it is determined that detection light is not emitted at the current scanning point, and a corresponding instruction is sent to the scanning control component 101. In addition, when the computing component 30 determines that the distance detected at the current light intensity is less than a predetermined value or greater than the predetermined value, it is determined that detection light is not emitted at the current scanning point, and a corresponding instruction is sent to the scanning control component 101. Alternatively, when the computing component 30 determines that a currently scanned target area is an unimportant and unattended area, it is determined that a current emission is skipped according to the second preset non-emission ratio, so that a corresponding instruction is sent to the scanning control component 101. In addition, when the computing component 30 determines that the divergence angle of a scan within the second preset time range has detected most of current pixels, it is determined that detection light is not emitted at the current scanning point, so that a corresponding instruction is sent to the scanning control component 101, and the control component 101 then controls the light-emitting unit 10 not to emit detection light according to the instruction. In an example, the computing component 30 is configured to perform the above operation of determining whether to emit detection light at the current scanning point before each scan. For example, the computing component 30 may be configured to: determine at least one sensing tensor obtained through a previous measurement that is closest in terms of time; determine at least another previous measurement that is closest in terms of spatial angle; and determine, based on the determined sensing tensor and the determined measurement, whether to emit detection light at the current scanning point. When it is determined that there is no need to send detection light, a corresponding instruction is sent to the scanning control component 101, so that under the control of the scanning control component 101, the light-emitting unit 10 does not need to send detection light to the target object. As an example, using the distance and light intensity values of a pixel from a previous scan in the current period (current frame), and using the distance and light intensity values of the same scanning point in a previous frame, when the light intensity is too large or the distance is less than 15 meters and larger than 5 meters (for example), no light is emitted currently.

In addition, in some existing technologies, it is necessary to use AI to identify the object first, and then determine whether to reduce the light intensity for scanning. In some other technologies, it is necessary to divide the target scenario into a limited number of areas and determine by area whether to scan with reduced light intensity or scan by changing scan density. Still in some existing technologies, it is necessary to only use a preset distance threshold, or only a preset light intensity threshold, to determine whether to reduce/increase the light intensity or change the density for the current scan. The system in this embodiment addresses, at least in part, the deficiencies in the existing technology.

Specific steps of obtaining the above sensing tensor by the computing component 30 according to an embodiment of the present disclosure are described below with reference to FIG. 4. As shown in step S101, the computing component 30 acquires a first sensing tensor in a previous period temporally closest to the current scanning point. Here, the information is pre-stored in chronological order in any suitable storage portion. In step S102, the computing component 30 acquires a second sensing tensor in a current period spatially closest to the current scanning point. Since the scanning angle and scanning time (current frame, or previous few frames) are known when each scan is performed, the second sensing tensor may be obtained based on the information. In the present disclosure, the current period/previous period may be a current/previous frame, or a horizontal scan of a line that is currently/previously completed.

In step S103, the computing component 30 determines an emission intensity, an emission frequency, an emission area, a pulse distinguishable characteristic, and a current scanning area in the current period, based on the sensing tensor in the current period, and the acquired first sensing tensor and second sensing tensor.

In step S104, the computing component 30 determines whether the light-emitting unit array 10 should be allowed to perform an operation of emitting light in the current period. In particular, the computing component 30 may determine that the light-emitting unit array 10 does not perform the light-emitting operation in the current period, and send a corresponding control instruction to the scanning control component 101 so that the light-emitting unit array 10 does not perform the light-emitting operation, as described above.

If a determination result in step S104 is “yes”, then in step S105, a sensing tensor of a largest possibly covered photosensitive unit corresponding to a current scanning angle and a current divergence angle is obtained, and then the processing returns to step S101, or if not the process skips back to step S101 directly.

In an embodiment, the computing component 30 is further configured to obtain at least one subregion of interest (attention) in the target scenario using the sensing tensor measured in the previous second preset time range. For example, point cloud data converted by a 1000×1000 resolution real-world 3D image sensor or virtual world 3D image in previous 5 frames may be connected into tensors at an input end of a deep learning neural network of a two-dimensional array (including RNN, CNN, ResNet, LSTM, GRU, sequence models, etc.), and the deep learning neural network has been trained when offline using a large amount of pre-annotated (e.g., manual annotation, annotation using computer simple primitives and object information, however, other automatic annotation methods are also allowed) data for outputting a subregion of interest corresponding to a 1000×1000 resolution scenario. Using the deep learning neural network, a subregion of interest that is output in real time may be obtained, where 1 indicates of interest, 0 indicates no interest, and 1 of different spatial orientations in multiple frame images indicates that multiple subregions receive attention at different times. Various numeral values are given here by way of examples, but the present disclosure is not limited thereto, for example, those skilled in the art may use other number of frames, other number of resolutions and other number of subregions of interest.

After obtaining at least one subregion of interest, the computing component 30 sends an instruction to the scanning control component 101 such that: in a third preset time range, compared to other regions, a scanning density of the subregion of interest is greater than a first multiple threshold, and/or a scanning frequency of the subregion of interest is greater or less than a second multiple threshold, and/or an average light energy of the subregion of interest per unit time is greater or less than a third multiple threshold. The second preset time range and the third preset time range may be, for example, 0.001 seconds, 0.1 seconds, 1 second, 10 seconds. Correspondingly, the region of interest may be better identified and faster detected. For example, there is a fast approaching vehicle ahead, it is necessary to provide a detection result faster. For example, some children are playing on the far side of the road, then it is necessary to scan more intensively to determine the children’s intentions and/or future actions.

FIG. 2 shows a 3D image sensor ranging system 100′ according to an embodiment of the present disclosure. As shown, the 3D image sensor ranging system 100′, in addition to including at least one light-emitting unit array 10, at least one photosensitive unit array 20 and at least one computing component 30, further includes at least one independent light scanning component 40, configured to control to scan in a spatial angle range corresponding to at least a part of the target scenario. Because the light-emitting unit array 10, the photosensitive unit array 20 and the computing component 30 have been described above accordingly, detailed description thereof will be omitted herein. Further, the light scanning component 40 may achieve the same function as the scanning control component 101, and has a similar configuration, therefore detailed description thereof is omitted herein.

According to an embodiment of the present disclosure, through the following steps: step 1) forming at least one 3D image sensor ranging system as described in any one of the above embodiments, and step 2) integrating the at least one 3D image sensor ranging system in a same semiconductor chip, thereby forming an apparatus for optical ranging. In other words, the apparatus for optical ranging formed according to the embodiment may include at least one 3D image sensor ranging system as described in any one of the above embodiments; and a semiconductor chip for integrating the at least one 3D image sensor ranging system therein. Those skilled in the art have clearly understood the specific configuration of the 3D image sensor ranging system through the above content, thus, based on the teachings of the present disclosure, some technical means well known in the art may be used to form the 3D image sensor ranging system described above and to perform the steps of integrating the system into the semiconductor.

FIG. 6 shows a method 200 for ranging using the 3D image sensor ranging system according to an embodiment of the present disclosure. As shown, the method 200 includes: step S201, emitting light to at least one target scenario through a light-emitting unit included in at least one light-emitting unit array; step S202, receiving at least a part of light emitted by the light-emitting unit and reflected by the target scenario through a photosensitive unit, and generating a sensing tensor based on the received light; and step S203, calculating at least one of a distance between the light-emitting unit array and the target scenario and a light intensity of the reflected light, based on the generated sensing tensor.

In step S201 of emitting light to at least one target scenario through a light-emitting unit included in at least one light-emitting unit array, a maximum value of a divergence angle of the light-emitting unit, which fluctuates with time, is greater than a first spatial resolution threshold. In this step, within a first preset time range, a random error of an actual scanning spatial angle of the light-emitting unit meeting a first preset angle-ratio and a preset scanning spatial angle is greater than the first spatial resolution threshold. As described above, the first spatial resolution threshold includes a horizontal first spatial resolution threshold and a vertical first spatial resolution threshold. The horizontal first spatial resolution threshold may be 0.1°, 1°, 2°, 5°, 10°, or 0.01*system horizontal field-of-view (FOV), or 0.02*system horizontal FOV, or 0.1*system horizontal FOV. The vertical first spatial resolution threshold may be 0.1°, 1°, 2°, 5°, 10°, or 0.01*system vertical FOV, or 0.02*system vertical FOV, or 0.1*system vertical FOV.

The sensing tensor may include at least one of: a distance between the light-emitting unit and the target scenario, a light intensity of the reflected light, a phase of the reflected light, or a spectrum of the reflected light. In this case, step S203 of the calculating may include: obtaining an emission time t0 of the light; obtaining a time t1 of a single photon or a single light pulse in the sensing tensor; determining the distance between the light-emitting unit and the target scenario based on the obtained emission time t0 and the time t1 of a single photon or a single light pulse; and determining the number of photosensitive electrons in the sensing tensor or a voltage reading of a collection capacitor as the light intensity of the reflected light.

According to an embodiment of the present disclosure, the photosensitive unit may include the circuit structure as shown in FIG. 5. That is, the photosensitive unit may include two capacitors C1 and C2, a variable shunt, and an avalanche diode APD. The photosensitive electrons are delivered to the two capacitors C1 and C2 by control of the variable shunt. In this case, step S203 of the calculating may include: obtaining an emission time t0 of the light; obtaining a voltage reading of the first capacitor C1 and a voltage reading of the second capacitor C2; determining an arrival time t1 of the light arriving at the photosensitive unit based on the voltage readings; calculating the distance between the light-emitting unit and the target scenario based on the obtained emission time t0 and the arrival time t1, i.e., (t1-t0) ×speed of light/2; and determining a sum of the voltage reading of the first capacitor C1 and the voltage reading of the second capacitor C2 as the light intensity of the emitted light.

As an option, step S203 of the calculating may further include: obtaining an emission time t0 of the light, and a preset emitted light pulse width T0; obtaining a time t_1 of the earliest electron group of 2 electrons arriving at a same photosensitive unit in the photosensitive unit array within a preset first time interval threshold T_1, where a time at which a second electron in the group arrives/appears at the same photosensitive unit is t_1+Δt₁, and at the same time obtaining the number n_1 of electron groups of 2 electrons arriving at the same photosensitive unit and satisfying the same interval condition, where Δt₁<T_1; then obtaining a time t_m of the earliest electron group of m+1 electrons arriving at the same photosensitive unit within a preset m-th time interval threshold T_m in sequence, and at the same time obtaining the number n_m of electron groups of m+1 electrons satisfying the same condition, where m is greater than or equal to 2; obtaining an electron group arrival time t_max={t_1, ...,t_m} corresponding to a maximum electron group number n_max=max{n1,...,n_m} using corresponding electron group numbers n_1,...,n_m; determining the distance between the light-emitting unit array and the target scenario based on a rule [distance= (t_max-t0) ×C/2 speed of light]; and determining the maximum electron group number n_max as the light intensity of the reflected light.

In another example, step S203 of the calculating may include: obtaining an emission time t0 of the light; obtaining a time t_1 of the earliest 2 electron groups simultaneously arriving at different but adjacent photosensitive units in the photosensitive unit array within a preset first time interval threshold, and at the same time obtaining the number n_1 of electron groups of 2 electrons arriving at the adjacent photosensitive units and satisfying the same interval condition; then obtaining a time t_m of earliest m+1 electron groups arrived within a preset m-th time interval threshold in sequence, and at the same time obtaining the number n_m of electron groups of m+1 electrons arriving at the adjacent photosensitive units and satisfying the same interval condition, where m≥2, and a corresponding electron group number n_m, and obtaining an electron group arrival time t_max corresponding to a maximum electron group number n_max; determining the distance between the light-emitting unit array and the target scenario based on a rule [distance= (t_max-t0) ×C/2 speed of light/2]; and determining the maximum electron group number n_max as the light intensity of the reflected light.

In an embodiment, in a process of emitting the light for scanning according to a predetermined pattern, based on a previous sensing tensor, it may be determined whether to emit detection light at a current scanning point, where there is at least the number of times no detection light is emitted within a second preset time range, the number of times satisfies a second preset non-emission ratio. For example, when it is determined that at least two light-emitting units scan the target scenario successively with strong light and weak light, respectively, and if the distance has been obtained by measuring during the scan with the weak light, it is determined that detection light is not emitted at the current scanning point. Alternatively, when it is determined that the distance detected at the current light intensity is less than a predetermined value or greater than the predetermined value, it is determined that detection light is not emitted at the current scanning point. Alternatively, when it is determined that a currently scanned target area is an unimportant and unattended area, it is determined that a current emission is skipped according to the second preset non-emission ratio. Alternatively, when it is determined that the divergence angle of a scan within the second preset time range has detected most of current pixels, it is determined that detection light is not emitted at the current scanning point. The second preset non-emission ratio may be 1%, 5%, 20%, 30%, or 80%. In addition, before each scan, it is determined whether to emit detection light at the current scanning point.

In an example, step S203 of the calculating may further include: determining at least one sensing tensor obtained through a previous measurement that is closest in terms of time; determining at least another previous measurement that is closest in terms of spatial angle; and determining, based on the determined sensing tensor and the determined measurement, whether to emit detection light at the current scanning point, where the sensing tensor may be obtained from the steps in the flowchart shown in FIG. 4.

In an example, it may also be determined whether the number or an amplitude of photosensitive electrons in received light is less than a predetermined electron number threshold or a signal amplitude threshold; and if yes, information included in the light is discarded, where the electron number threshold and the signal amplitude threshold gradually decrease with time. In addition, in step S201 of the emitting, beams emitted simultaneously by the light-emitting units at least partially overlap in a spatial angle, and a wavelength range included in each of the beams is at least partially different. The light-emitting units may emit scanning beams of at least two different divergence angles to the target scenario.

In addition, step S203 of the calculating may further include: obtaining at least one subregion of interest in the target scenario using the sensing tensor measured in the previous second preset time range; and sending an instruction such that: in a third preset time range, compared to other regions, a scanning density of the subregion of interest is greater than a first multiple threshold, and/or a scanning frequency of the subregion of interest is greater or less than a second multiple threshold, and/or an average light energy of the subregion of interest per unit time is greater or less than a third multiple threshold.

In addition, at least one subregion of interest may also be determined by an embedded calculation and/or preset pattern in the light-emitting unit, where in step S201, the light-emitting unit outputs a sensing tensor with the number of subpixels of an image sensor less than the second preset ratio. The second preset ratio may be, for example, 1%, 5%, 20%, 30%, or 80%.

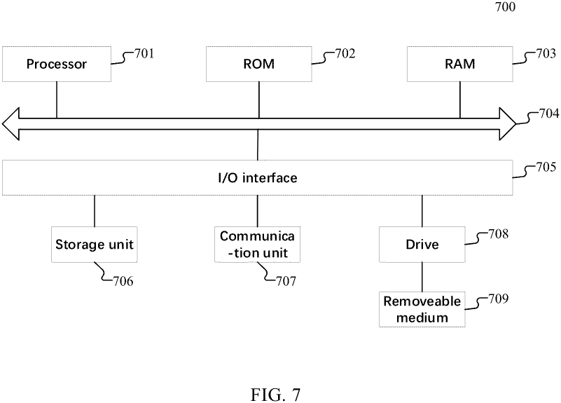

With further reference to FIG. 7, a schematic structural diagram of a computer system 700 of an electronic device suitable for implementing the 3D imaging method of embodiments of the present disclosure is shown. The electronic device shown in FIG. 7 is merely an example, and should not impose any limitation on the function and scope of use of the embodiments of the present disclosure.

As shown in FIG. 7, the computer system 700 includes one or more processors 701 (e.g., CPU), which may execute various appropriate actions and processes in accordance with a program stored in a read-only memory (ROM) 702 or a program loaded into a random access memory (RAM) 703 from a storage unit 706. The RAM 703 also stores various programs and data required by operations of the system 700. The processor 701, the ROM 702 and the RAM 703 are connected to each other through a bus 704. An input/output (I/O) interface 705 is also connected to the bus 704.

The following components are connected to the I/O interface 705: a storage unit 706 including a hard disk and the like, and a communication unit 707 including network interface cards such as LAN cards and modems. The communication unit 707 performs communication processing via a network such as the Internet. The drive 708 is also connected to the I/O interface 705 as required. A removable medium 709, such as a disk, an optical disk, a magnetooptical disk, a semiconductor memory, etc., is installed on the drive 708 as required so that a computer program read from it can be installed in the storage unit 706 as required.

In particular, according to the embodiments of the present disclosure, the process described above with reference to the flow chart may be implemented as a computer software program. For example, the embodiments of the present disclosure include a computer program product, which includes a computer program that is tangibly embedded in a computer readable medium. The computer program includes a program code for executing the method as shown in the flow chart. In such an embodiment, the computer program may be downloaded and installed from a network via the communication unit 707, and/or be installed from the removable medium 709. The computer program, when executed by the central processing unit 701, implements the above functions as defined by the method of the present disclosure. It should be noted that the computer readable medium of the present disclosure may be a computer readable signal medium or a computer readable storage medium, or any combination of the above two. An example of the computer readable storage medium may include, but is not limited to: electric, magnetic, optical, electromagnetic, infrared, or semiconductor systems, apparatuses, elements, or a combination of any of the above. A more specific example of the computer readable storage medium may include, but is not limited to: an electrical connection with one or more pieces of wire, a portable computer disk, a hard disk, a random-access memory (RAM), a read only memory (ROM), an erasable programmable read-only memory (EPROM or flash memory), an optical fiber, a portable compact disk read-only memory (CD-ROM), an optical memory, a magnetic memory, or any suitable combination of the above. In the present disclosure, the computer readable storage medium may be any tangible medium containing or storing programs which may be used by, or used in combination with, a command execution system, apparatus or element. In the present disclosure, the computer readable signal medium may include a data signal in the base band or propagating as a part of a carrier wave, in which a computer readable program code is carried. The propagating data signal may take various forms, including but not limited to an electromagnetic signal, an optical signal, or any suitable combination of the above. The computer readable signal medium may also be any computer readable medium except for the computer readable storage medium. The computer readable signal medium is capable of transmitting, propagating or transferring programs for use by, or use in combination with, a command execution system, apparatus or element. The program code contained on the computer readable medium may be transmitted with any suitable medium, including but not limited to: wire, an optical cable, a RF (radio frequency) medium etc., or any suitable combination of the above.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user’s computer, partially executed on a user’s computer, executed as a separate software package, partially executed on a user’s computer and partially executed on a remote computer, or completely executed on a remote computer or server. In the case where a remote computer is involved, the remote computer may be connected to a user computer through any kind of networks, including a local area network (LAN) or a wide area network (WAN), or may be connected to an external computer (for example, connected through the Internet using an Internet service provider).

The flow charts and block diagrams in the figures illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, functions annotated in the blocks may also occur in an order different from the order annotated in the figures. For example, any two blocks presented in succession may be executed substantially in parallel, or sometimes be executed in a reverse sequence, depending on the functions involved. It should also be noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor, for example, may be described as: a processor including an acquisition unit and a 3D image generation unit. Here, the names of these units do not in some cases constitute limitations to such units themselves. For example, the acquisition unit may also be described as “a unit configured to acquire depth information for at least one pixel corresponding to a point in a to-be-captured scenario”.

As another aspect, the present disclosure also provides a computer readable medium. The computer readable medium may be included in the apparatus described in the above embodiment; or a stand-alone computer readable medium not assembled into the apparatus. The computer readable medium carries one or more programs. The one or more programs, when executed by the apparatus, cause the apparatus to perform the ranging method described above.

The above description only provides explanation of the preferred embodiments and the employed technical principles of the present disclosure. It should be appreciated by those skilled in the art that the inventive scope involved in the present disclosure is not limited to the technical solutions formed by the particular combinations of the above technical features. The inventive scope should also cover other technical solutions formed by any combination of the above technical features or equivalent features thereof without departing from the inventive concept of the present disclosure, for example, the technical solutions formed by interchanging the above features with, but not limited to, technical features with similar functions disclosed in the present disclosure.

What is claimed is:

1. A 3D image sensor ranging system, comprising:
at least one light-emitting unit array, each of the light-emitting unit array comprising at least one light-emitting unit, configured to emit light to a target scenario;
at least one photosensitive unit array, each of the photosensitive unit array comprising at least one photosensitive unit, configured to receive at least a part of light emitted by the light-emitting unit and reflected by the target scenario, and generate a sensing tensor based on received light; and
at least one computing component, configured to calculate at least one of a distance between the light-emitting unit and the target scenario or a light intensity of the reflected light of the emitted light, wherein the distance and the light intensity correspond to an angle of the emitted light, based on the sensing tensor generated by the at least one photosensitive unit.

2. The 3D image sensor ranging system according to claim 1, wherein a divergence angle of the light emitted by the light-emitting unit fluctuates with emitting time, wherein a maximum value of the divergence angle is greater than a first spatial resolution threshold.

3. The 3D image sensor ranging system according to claim 2, wherein the system further comprises:
a scanning component, configured to control the light-emitting unit array to perform irradiation scanning in a spatial angle range corresponding to at least a part of the target scenario; or
wherein at least a part of the light-emitting unit array comprises a light-emitting scanning control component, configured to control the light-emitting unit array to perform irradiation scanning in a spatial angle range corresponding to the target scenario.

4. The 3D image sensor ranging system according to claim 3, wherein, within a first preset time range, a desired random error of an actual scanning spatial angle of the light emitted by the light-emitting unit array and a preset scanning spatial angle is greater than the first spatial resolution threshold, while an amount of the actual scanning spatial angle meets at least a first preset angle-ratio.

5. The 3D image sensor ranging system according to claim 2, wherein the first spatial resolution threshold is greater than 2 times of a spatial resolution of the 3D image sensor ranging system.

6. The 3D image sensor ranging system according to claim 4, wherein the sensing tensor comprises at least one of: a distance between the light-emitting unit and the target scenario, a light intensity of the emitted light, a phase of the emitted light, or a spectrum of the emitted light.

7. The 3D image sensor ranging system according to claim 6, wherein the photosensitive unit comprises a photoelectric sensor, the photoelectric sensor generates photosensitive electrons in response to receiving the reflected light through a photoelectric effect, and
wherein the computing component is configured to:
obtain an emission time t0 of the light;
obtain an arrival time t1 of a single photon or a single light pulse in the sensing tensor arriving at the photosensitive unit;
determine the distance between the light-emitting unit and the target scenario based on the obtained t0 and t1; and
determine the number of photosensitive electrons in the sensing tensor or a voltage reading of a collection capacitor in the photosensitive unit as the light intensity.

8. The 3D image sensor ranging system according to claim 6, wherein each of the photosensitive unit comprises a first capacitor C1 and a second capacitor C2, and the computing component is configured to:
obtain an emission time t0 of the light;
obtain a voltage reading of the first capacitor C1 and a voltage reading of the second capacitor C2;
determine an arrival time t1 of the light arriving at the photosensitive unit based on the voltage readings;
calculate the distance between the light-emitting unit and the target scenario based on the obtained t0 and t1; and
calculate the light intensity based on the voltage reading of the first capacitor C1 and the voltage reading of the second capacitor C2.

9. The 3D image sensor ranging system according to claim 6, wherein the computing component is configured to:
obtain an emission time t0 of the light;
obtain a time t_1 of an earliest electron group of 2 electrons arriving at a same photosensitive unit in the photosensitive unit array within a preset first time interval threshold T_1, wherein a time at which a second electron in the group arrives/appears at the same photosensitive unit is t_1+Δt₁, and at the same time, obtain the number n_1 of electron groups of 2 electrons arriving at the same photosensitive unit and satisfying a same interval condition, wherein Δt₁<T_1;
obtain a time t_m of an earliest electron group of m+1 electrons arriving at the same photosensitive unit within a preset m-th time interval threshold T_m in sequence, and at the same time obtain the number n_m of electron groups of m+1 electrons satisfying the same condition, where m is greater than or equal to 2;
obtain an electron group arrival time t_max={t_1, ...,t_m} corresponding to a maximum electron group number n_max=max{n1, ...,n_m} using corresponding electron group numbers n_1,...,n_m;
determine the distance based on a rule [distance=(t_max-t0)×C/2 speed of light]; and
determine the maximum electron group number n_max as the light intensity.

10. The 3D image sensor ranging system according to claim 6, wherein the computing component is configured to:
obtain an emission time t0 of the light;
obtain a time t_1 of earliest 2 electron groups simultaneously arriving at different but adjacent photosensitive units in the photosensitive unit array within a preset first time interval threshold, and at the same time obtain the number n_1 of electron groups of 2 electrons arriving at the adjacent photosensitive units and satisfying the same interval condition;
obtain a time t_m of earliest m+1 electron groups arrived within a preset m-th time interval threshold in sequence, and at the same time obtain the number n_m of electron groups of m+1 electrons arriving at the adjacent photosensitive units and satisfying the same interval condition, wherein m≥2, and a corresponding electron group number n_m, and obtain an electron group arrival time t_max corresponding to a maximum electron group number n_max;
determine the distance based on a rule [distance=(t_max-t0)×C/2 speed of light/2]; and
determine the maximum electron group number n_max as the light intensity.

11. The 3D image sensor ranging system according to claim 3, wherein the computing component is configured to:
determine whether to emit detection light at a current scanning point based on a previous sensing tensors before a current scanning point in a process of performing scanning according to a predetermined pattern, wherein there is at least the number of times no detection light is emitted within a second preset time range, the number of times satisfying a second preset non-emission ratio.

12. The 3D image sensor ranging system according to claim 11, wherein, when the computing component determines that at least two light-emitting units scan the target scenario successively with strong light and weak light, respectively, and if the distance has been obtained by measuring during the scan with the weak light, it is determined that detection light is not emitted at the current scanning point; or
when the computing component determines that the distance detected at a current light intensity is less than a predetermined value or greater than the predetermined value, it is determined that detection light is not emitted at the current scanning point; or
when the computing component determines that a currently scanned target area is an unimportant and unattended area, it is determined that a current light emission is skipped according to the second preset non-emission ratio; or
when the computing component determines that the divergence angle of a scan within the second preset time range has detected most of current pixels, it is determined that detection light is not emitted at the current scanning point.

13. The 3D image sensor ranging system according to claim 1, wherein the computing component is configured to:
determine, for the current scanning point, at least one sensing tensor obtained through a previous measurement that is closest in terms of time;
determine at least another previous measurement that is closest in terms of spatial angle; and
determine, based on the determined sensing tensor and the determined measurement, whether to emit the detection light at the current scanning point.

14. The 3D image sensor ranging system according to claim 1, wherein each photosensitive unit is configured to:
determine whether the number or an amplitude of photosensitive electrons in received light pulses is less than a predetermined electron number threshold or a signal amplitude threshold; and if yes, discard information comprised in the light pulses, wherein the electron number threshold and the signal amplitude threshold gradually decrease from a preset threshold with time at beginning of emission according to a preset pattern.

15. The 3D image sensor ranging system according to claim 1, wherein the computing component is further configured to obtain at least one subregion of interest in the target scenario using the sensing tensor measured in the previous second preset time range; and send an instruction such that:
in a third preset time range, compared to other regions, a scanning density of the subregion of interest is greater than a first multiple threshold, and/or a scanning frequency of the subregion of interest is greater or less than a second multiple threshold, and/or an average light energy of the subregion of interest per unit time is greater or less than a third multiple threshold.

16. A ranging method using the 3D image sensor ranging system, comprising:
emitting light to at least one target scenario through a light-emitting unit comprised in at least one light-emitting unit array;
receiving at least a part of light emitted by the light-emitting unit and reflected by the target scenario through a photosensitive unit, and generating a sensing tensor based on the received light; and
calculating at least one of a distance between the light-emitting unit and the target scenario or a light intensity of the reflected light of the emitted light, wherein the distance and the light intensity correspond to an angle of the emitted light, based on the generated sensing tensor.

17. The method according to claim 16, wherein in a step of the emitting light to at least one target scenario through a light-emitting unit, a divergence angle of the light emitted by the light-emitting unit fluctuates with emitting time, wherein a maximum value of the divergence angle is greater than a first spatial resolution threshold.

18. The method according to claim 17, wherein, within a first preset time range, a desired random error of an actual scanning spatial angle of the light-emitting unit meeting at least a first preset angle-ratio and a preset scanning spatial angle is greater than the first spatial resolution threshold.

19. The method according to claim 18, wherein the sensing tensor comprises at least one of: a distance between the light-emitting unit and the target scenario, a light intensity of the emitted light, a phase of the reflected light, or a spectrum of the emitted light.

20. The method according to claim 19, wherein the photosensitive unit comprises a photoelectric sensor, the photoelectric sensor generates photosensitive electrons in response to receiving the reflected light through a photoelectric effect, and
wherein a step of the calculating comprises:
obtaining an emission time t0 of the light;
obtaining an arrival time t1 of a single photon or a single light pulse in the sensing tensor arriving at the photosensitive unit;
determining the distance between the light-emitting unit and the target scenario based on the obtained t0 and t1; and
determining the number of photosensitive electrons in the sensing tensor or a voltage reading of a collection capacitor as the light intensity.

21. The method according to claim 19, wherein the photosensitive unit comprises a first capacitor C1 and a second capacitor C2, and a step of the calculating comprise:
obtaining an emission time t0 of the light;
obtaining a voltage reading of the first capacitor C1 and a voltage reading of the second capacitor C2;
determining an arrival time t1 of the light arriving at the photosensitive unit based on the voltage readings;
calculating the distance between the light-emitting unit and the target scenario based on the obtained t0 and t1; and
determining a sum of the voltage reading of the first capacitor C1 and the voltage reading of the second capacitor C2 as the light intensity.

22. The method according to claim 19, wherein a step of the calculating comprises:
obtaining an emission time t0 of the light;
obtaining a time t_1 of an earliest electron group of 2 electrons arriving at a same photosensitive unit in the photosensitive unit array within a preset first time interval threshold T_1, wherein a time at which a second electron in the group arrives/appears at the same photosensitive unit is t_1+Δt₁, and at the same time, obtaining the number n_1 of electron groups of 2 electrons arriving at the same photosensitive unit and satisfying a same interval condition, wherein Δt₁<T_1;
obtaining a time t_m of an earliest electron group of m+1 electrons arriving at the same photosensitive unit within a preset m-th time interval threshold T_m in sequence, and at the same time obtaining the number n_m of electron groups of m+1 electrons satisfying the same condition, where m is greater than or equal to 2;
obtaining an electron group arrival time t_max={t_1,...,t_m} corresponding to a maximum electron group number n_max=max{n1,...,n_m} using corresponding electron group numbers n_1,...,n_m;
determining the distance based on a rule [distance=(t_max-t0)×C/2 speed of light]; and
determining the maximum electron group number n_max as the light intensity.

23. The method according to claim 19, wherein a step of the calculating comprises:
obtaining an emission time t0 of the light;
obtaining a time t_1 of earliest 2 electron groups simultaneously arriving at different but adjacent photosensitive units in the photosensitive unit array within a preset first time interval threshold, and at the same time obtaining the number n_1 of electron groups of 2 electrons arriving at the adjacent photosensitive units and satisfying the same interval condition;
obtaining a time t_m of earliest m+1 electron groups arrived within a preset m-th time interval threshold in sequence, and at the same time obtaining the number n_m of electron groups of m+1 electrons arriving at the adjacent photosensitive units and satisfying the same interval condition, wherein m≥2, and a corresponding electron group number n_m, and obtaining an electron group arrival time t_max corresponding to a maximum electron group number n_max;
determining the distance based on a rule [distance=(t_max-t0)×C/2 speed of light/2]; and
determining the maximum electron group number n_max as the light intensity.

24. The method according to claim 16, wherein the method further comprises:
determining whether to emit detection light at a current scanning point based on a previous sensing tensor in a process of emitting the light for scanning according to a predetermined pattern, wherein there is at least the number of times no detection light is emitted within a second preset time range, the number of times satisfying a second preset non-emission ratio.

25. The method according to claim 24, wherein, when it is determined that at least two light-emitting units scan the target scenario successively with strong light and weak light, respectively, and if the distance has been obtained by measuring during the scan with the weak light, it is determined that detection light is not emitted at the current scanning point; or
when it is determined that the distance detected at a current light intensity is less than a predetermined value or greater than the predetermined value, it is determined that detection light is not emitted at the current scanning point; or
when it is determined that a currently scanned target area is an unimportant and unattended area, it is determined that a current emission is skipped according to the second preset non-emission ratio; or
when it is determined that the divergence angle of a scan within the second preset time range has detected most of current pixels, it is determined that detection light is not emitted at the current scanning point.

26. The method according to claim 16, wherein steps of the calculation comprise:
determining at least one sensing tensor obtained through a previous measurement that is closest in terms of time;
determining at least another previous measurement that is closest in terms of spatial angle; and
determining, based on the determined sensing tensor and the determined measurement, whether to emit the detection light at the current scanning point.

27. The method according to claim 16, wherein the method further comprises:
determining whether the number or an amplitude of photosensitive electrons in received light pulses is less than a predetermined electron number threshold or a signal amplitude threshold; and if yes, discarding information comprised in the light pulses, wherein the electron number threshold and the signal amplitude threshold gradually decrease from a preset threshold with time at beginning of emission according to a preset pattern.

28. The method according to claim 16, wherein a step of the calculating further comprises: obtaining at least one subregion of interest in the target scenario using the sensing tensor measured in the previous second preset time range; and sending an instruction such that:
in a third preset time range, compared to other regions, a scanning density of the subregion of interest is greater than a first multiple threshold, and/or a scanning frequency of the subregion of interest is greater or less than a second multiple threshold, and/or an average light energy of the subregion of interest per unit time is greater or less than a third multiple threshold.

29. An apparatus for optical ranging, comprising:
at least one 3D image sensor ranging system comprising
at least one light-emitting unit array, each of the light-emitting unit array comprising at least one light-emitting unit, configured to emit light to a target scenario;
at least one photosensitive unit array, each of the photosensitive unit array comprising at least one photosensitive unit, configured to receive at least a part of light emitted by the light-emitting unit and reflected by the target scenario, and generate a sensing tensor based on received light; and
at least one computing component, configured to calculate at least one of a distance between the light-emitting unit array and the target scenario or a light intensity of the reflected light based on the sensing tensor generated by the photosensitive unit; and
a semiconductor chip, wherein the at least one 3D image sensor ranging system is integrated in the semiconductor chip.
